(19) United States
(12) Patent Application Publication
(10) Pub. No.: US 2008/0007761 A1
(43) Pub. Date: Jan. 10, 2008

(54) Printer

(75) Inventor: Motokazu Nishio, Yao-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/824,061

(22) Filed: Jun. 29, 2007

(30) Foreign Application Priority Data
Jun. 30, 2006 (JP) 2006-181931

(51) Int. Cl. G06K 15/00

(52) U.S. Cl. 358/1.14

(57) ABSTRACT

A printer includes an obtaining section for obtaining printing data, a storage section for storing the printing data obtained by the obtaining section, a printing section for printing the printing data stored in the storage section, an receiving section for receiving information about the printer, and a control section for extracting predetermined information about the printing data from the printing data and protecting the confidentiality of the printing data on the basis of the extracted information and the information received by the receiving section.

### CROSS-REFERENCE TO RELATED APPLICATIONS

This Nonprovisional application claims priority under 35 U.S.C. §119(a) on Patent Application No. 2006-181931 filed in Japan on Jun. 30, 2006, the entire contents of which are hereby incorporated by reference.

### BACKGROUND

1. Technical Field

The present application relates to a printer for receiving and storing printing data to be printed and conducting the action of printing the printing data on a recording medium on the basis of the stored printing data, and more particularly, to a printer capable of preserving confidentiality of the printing data with.

2. Description of the Related Art

By connecting a printer with two or more computers via a network such as LAN (local area network) to constitute a printing system, it is possible to share the printer as common hardware resource among by the users of the computers. In general, the printing media (for example, sheets of recording paper) in such a normal-printer are accessible by any one when printed and discharged from the printer to the outside, hence, it is difficult to keep the printing data confidential.

In particular, when the printer is operated at the discretion of users who are employees in a company or office, the confidential data may be leaked through the printing media by any of the employees, and there arises a problem of wasteful use of resources such as printing paper or toner.

For protecting confidentiality, a system has been developed as disclosed in Japanese Laid-open Patent Publication No. 2001-121781 where printing data requiring no confidentiality is supplied to a general data printer while printing data requiring confidentiality is subjected to a holding action and, after successful authentication of the owner, is outputted to a confidential data printer.

Disclosed in Japanese Laid-open Patent Publication No. 2005-319673 is a system where a printer with no holding function share a holding function provided in another printer, and thereby a virtual holding function is realized.

A still another printing system is disclosed in Japanese Laid-open Patent Publication No. 2005-349642 where printing data is subjected to a holding action and then selectively erased or saved depending on its type.

It is necessary for protecting confidentiality in printing to firstly determine whether or not the printing data to be printed is classified into the data requiring confidentiality before actually subjected to the printing action. In both Japanese Laid-open Patent Publications Nos. 2001-121781 and 2005-349642, the action of determination and selection is carried out by the user. Accordingly, as the protection of confidentiality depends on the action of the user, the data may be mishandled by an accidental or intentional action of the user and the reliability in the protection of confidentiality may be degraded.

It is further necessary to determine from the information about the printing data and the printer (including the location of the apparatus and the installation of an optional device) whether or not the printing data of interest should be subjected to the printing action in which the confidentiality is protected. For example, when the printer is located in a place accessible by any person other than the employees in a company or office and the printing data including the company secret is simply outputted therefrom, the outputted prints may be brought out of the company or office. For preventing the leakage of secret, the printing with confidentiality protection has to be performed.

However, the conventional systems described above fail to clarify the action of printing the printing data of interest according to a combination of the printing data and the information about the printer, hence reliability in security protection and the productivity could be deteriorated.

### SUMMARY

The present application has been made in view of the foregoing problems and its object is to provide a printer capable of protecting confidentiality of printing data according to information about the printing data and information about the printer.

It is another object of the present application to provide a printer capable of indirectly suppressing the consumption of resources such as printing paper and toner through protecting confidentiality of printing data depending on the information about the printing data.

A printer according to the present application includes means for acquiring printing data, means for storing the printing data received by the receiving means, means for printing the printing data saved in the storing means, means for accepting information about the printer, means for extracting a piece of predetermined information about the printing data from the printing data stored in the storing means, and means for performing processing for protecting confidentiality of the printing data on the basis of the predetermined piece of information about the printing data extracted by the extracting means and the information accepted by the accepting means.

According to an aspect of the present application, the information accepted by the accepting unit includes information indicative of the location of installation of the printer.

According to an aspect of the present application, the information accepted by the accepting unit includes information indicating that the printer has means for erasing the printing data stored in the storing unit after the completion of the printing action.

According to an aspect of the present application, the predetermined information about the printing data includes a keyword indicative of a level of the confidentiality of the printing data.

According to an aspect of the present application, the predetermined information about the printing data includes information indicative of a range of the location of installation while the printer further includes means for determining whether or not the location of installation is within the range and means for protecting the confidentiality of the printing data in response to the result of the determination.

According to an aspect of the present application, the predetermined information about the printing data includes a mark indicative of a confidentiality level of the printing data.

According to an aspect of the present application, the predetermined information about the printing data includes a print job name indicative of a confidentiality level of the printing data.

According to an aspect of the present application, the predetermined information about the printing data includes information specifying an individual.

According to an aspect of the present application, the predetermined information about the printing data includes information indicative of the time and/or date when a printing action of the printing data is conducted.

According to an aspect of the present application, the predetermined information about the printing data includes information indicative of the size of the printing data.

According to an aspect of the present application, the predetermined information about the printing data includes information indicative of the type of printing paper on which the printing data is printed.

According to an aspect of the present application, the predetermined information about the printing data includes information indicative of the size of printing paper on which the printing data is printed.

According to an aspect of the present application, the predetermined information about the printing data includes information indicative of the number of pages of the printing data to be printed.

According to an aspect of the present application, the predetermined information about the printing data includes information indicating that the printing of the printing data is to be performed on both sides or one side of a sheet of the printing paper.

According to an aspect of the present application, the predetermined information about the printing data includes information indicative of a color of the printing data to be printed.

According to an aspect of the present application, the printer further includes a plurality of paper feed trays for containing sheets of printing paper to be supplied to the printing means, and the predetermined piece of information about the printing data includes a piece of information indicative of one of the paper feed trays for supplying a sheet of the printing paper on which the printing data is to be printed.

According to an aspect of the present application, the printer further includes a plurality of paper discharge trays for discharging sheets of the printed paper, and the predetermined information about the printing data includes information indicative of one of the paper discharge trays for discharging a sheet of the printing paper on which the printing data is printed.

According to an aspect of the present application, the printer further includes means for determining whether or not start of printing of the printing data is suspended and a means for suspending or executing start of printing of the printing data in accordance with the result of the determination.

According to an aspect of the present application, the printer further includes transfer means for transferring the printing data to another printer, means for determining whether or not the printing data subjected to the suspension of start of printing is transferred by the transfer means to another printer, and means for suspending or executing a transfer of the printing data with the transferring means in accordance with the result of the determination.

According to an aspect of the present application, the printer further includes means for determining whether or not the printing data stored in the storing means is to be deleted after the completion of the printing action and means for erasing the printing data when it is determined that the printing data should be deleted.

According to an aspect of the present application, the printer further includes means for making inquiry to the outside for permitting or prohibition of printing of the printing data stored in the storing means and means for receiving information indicative of the permission or prohibition of the printing inquired by the inquiring means, and when the permission of printing is received, the printing of the printing data is executed by the printing means.

According to an aspect of the present application, the printer includes means for notifying a method for printing the printing data to the outside when the permission of printing is received.

Therefore, with the printer according to the present application, the confidentiality of the printing data can be protected according to a combination of information about the printing data and information about the printer.

With the printer according to the present application, the confidentiality of the printing data can be protected according to the installation location of the printer (for example, a place accessible only by the employees of a company or office or a public space accessible by any people other than the employees).

With the printer according to the present application, the confidentiality of the printing data can be protected depending on the installation of a security device (which is capable of erasing the printing data subjected to a holding action after the completion of the printing action) to the printer.

With the printer according to the present application, the confidentiality of the printing data can be protected depending on the keyword indicative of a level of the confidentiality of the printing data in the printing data, or the presence/absence of the keyword.

With the printer according to the present application, the confidentiality of the printing data can be protected according to a combination of the installation location of the printer and the keyword (such as company secret or department secret) in the printing data.

With the printer according to the present application, the confidentiality of the printing data can be protected according to the presence/absence a mark (watermark) even when a keyword indicative of a level of the confidentiality of the printing data is not present in the printing data.

With the printer according to the present application, the confidentiality level of the printing data can be measured easily and readily. Since the confidentiality of the printing data is protected according to a print job name, an accidental or intentional leakage of the printing data (from a company or office) can preliminarily be avoided.

With the printer according to the present application, the confidentiality of the printing data can be protected according to a user who conducts the printing action, and thus any accidental or intentional leakage of the printing data (from a company or office) can preliminarily be avoided.

With the printer according to the present application, the confidentiality of a printing data can be protected according to the time and/or date of the printing action, and thus any accidental or intentional leakage of the printing data (from a company or office) can be preliminarily avoided. For example, the confidentiality of the printing data is protected when the printer located at a place accessible by any person other than the employees is operated during office hours (9:00 to 17:00) during which there are many comings and goings of people at the place.

With the printer according to the present application, start of printing is suspended when the data size is large enough to delay the printing action to be performed by a third party, hence giving priority to the printing action of the third party. Also, when the same data is to be printed repeatedly by a same user, a lead time to the printing action for the printing data can be minimized.

With the printer according to the present application, the confidentiality of the printing data can be protected, and an unnecessary printing action performed on e.g., an expensive type of printing paper can be suppressed.

With the printer according to the present application, the confidentiality of the printing data can be protected, and an a printing action performed on e.g., a particular size of printing paper which are running out of stock can be prevented.

With the printer according to the present application, the confidentiality of the printing data can be protected, and an unnecessary printing action performed e.g., in an excessive amount can be suppressed.

With the printer according to the present application, the confidentiality of the printing data can be protected, and a printing action for producing, e.g., an excessive number of prints can be prevented.

With the printer according to the present application, the confidentiality of the printing data can be protected, and an unnecessary printing action for producing, e.g., color prints can be prevented.

With the printer according to the present application, the confidentiality of the printing data can be protected, and an unnecessary printing action performed on e.g., a specific type of printing paper supplied from a hand-feed tray can be prevented.

The printer according to the present application can suppress the resultant prints to be discharged to a common discharge tray which is not provided with confidentiality protection not to an individual discharge tray provided with confidentiality protection.

With the printer according to the present application, the confidentiality of the printing data can be protected until the user who conducts the printing action arrives at the printer by suspending the start of printing of the printing data for which the confidentiality should be protected.

The printer according to the present application allows the printing data stored in the storing means to be deleted after the completion of a printing action, thus preventing any leakage of the printing data caused by theft or the like of the storing means.

With the printer according to the present application, the confidentiality of the printing data can be protected through transferring the printing data which requires confidentiality to another printer equipped with a security device when the printer is not equipped with a security device for erasing the printing data stored in the storing means after the completion of the printing action.

With the printer according to the present application, the confidentiality of the printing data can be protected, and the printing action by any of the employees at a department in a company or office can be controlled by a manager, thus controlling the protection of the confidentiality and the reduction in cost.

With the printer according to the present application, the confidentiality of the printing data can be protected, and the printing action by any of the employees at a department in the company or office can be controlled by a manager such that, for example, the printing data, for which the start of the printing is suspended, can be printed by the employee only when the printing thereof is permitted by the manager in the company or office, thus ensuring the protection of the confidentiality and the reduction in cost.

The above and further objects and features of the application will more fully be apparent from the following detailed description with accompanying drawings.

### BRIEF DESCRIPTION OF THE SEVERAL VIEWS OF THE DRAWINGS

FIG. 1 is a block diagram showing an arrangement of a printing system where a printer according to the present embodiment is provided;

FIG. 2 is an explanatory view showing an image example of a printer data table;

FIG. 3 is an explanatory view showing an image example of a printing condition table;

FIG. 4 is an explanatory view showing an example print of printing data;

FIG. 5 is an explanatory view schematically showing an installation location of the printers and personal computers;

FIG. 6 is a flowchart showing an example of action of the printer according to the present embodiment;

FIG. 7 is a flowchart showing an example of action of the printer according to the present embodiment;

FIG. 8 is an explanatory view showing an image example of a user identification table;

FIG. 9 is a flowchart showing an example of action of the printer according to the present embodiment;

FIG. 10 is a flowchart showing an action of the printer according to the present embodiment;

FIG. 11 is an explanatory view showing an image example of a holding condition table; and

FIG. 12 is an explanatory view showing an example print of printing data including a watermark.

### DETAILED DESCRIPTION

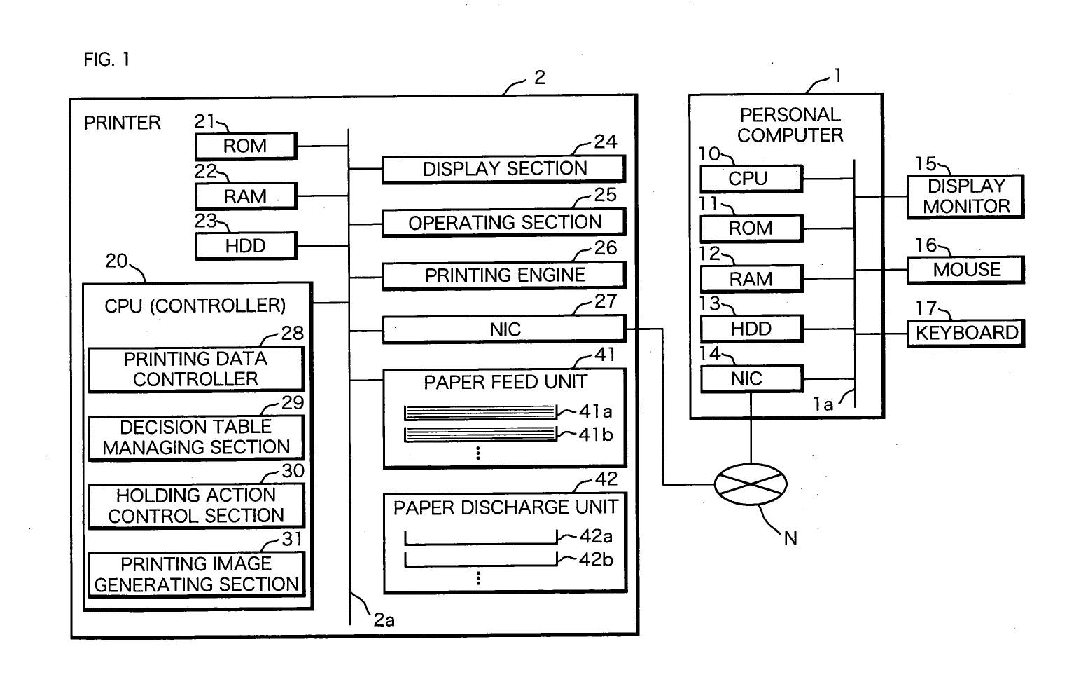

One embodiment of the present application will be described referring to the relevant drawings. FIG. 1 is a block diagram of an arrangement of a printing system which includes a printer according to the embodiment of the present embodiment. In the printing system, the printer 2 serves as a network printer and is connected via a network N, such as LAN (local area network) to a host computer 1 (referred to as a personal computer hereinafter), such as a personal computer, a work station, or a main frame computer. The printer 2 is arranged for printing images on the sheets of recording paper in response to print data received from the personal computer 1.

The printer 2 includes a CPU 20, a ROM 21, a RAM 22, an HDD 23, a display section 24, an operating section 25, a printing engine 26, an NIC (network interface card) 27, and other components which are connected to each other via a bus 2a. The CPU 20 is provided for controlling the action of the foregoing hardware components connected to each other via the bus 2a while reading control programs from the ROM 21 and the HDD (hard disk drive) 23 and executing them in the RAM 22. Also, the printer 2 includes a printing data controller 28 for executing the control programs, a decision table managing section 29, a holding action control section 30, and a printing image generating section 31. Moreover, the printer 2 includes a paper feed unit 41 equipped with a set of paper supply trays 41a, 41b . . . and a paper discharge unit 42 equipped with a set of paper receiver trays 42a, 42b . . . so that a desired paper supply tray and the paper receiver tray can be selected by a command from the controller 28.

The ROM 21 is provided where the control programs are stored for determining the action of the printer 2. The RAM 22 is implemented by an SRAM (static RAM) or a flash memory where the data generated by the CPU 20 during executing the control programs are temporarily stored.

The HDD (storage unit) 23 is a large capacity storage device for storing the control programs to be used for controlling the action of the printer 2, menu images to be displayed on the display section 24, printing data received over the network N from the external personal computers 1, 1 . . . and others. The printing data received from the personal computers 1, 1 . . . may be written in PCL (printer control language) or PS (post script) forms.

Also, stored in the HDD 23 are a printing data storage processing program for instructing the HDD 23 to store the printing data received from the personal computers 1, 1 . . . , a printing image generation processing program for converting the printing data stored in the HDD 23 into a printing image (for example, bit map data) for forming an image, a holding action controlling program for determining and controlling whether the printing data has to be saved or not, and a decision table managing program for managing the data required for determining whether the printing data has to be saved or not.

The printer 2 can thus be functioned as a printer with the CPU 20 executing the control programs.

The display section 24 is implemented by, for example, a liquid crystal display (LCD) for displaying data to be notified to the user, the action state of the printer 2, input data received from the operating section 25, and so on. The operating section 25 is equipped with an array of operating buttons for the user to enter its command. The display section 24 may be implemented by a touch panel for replacing partially or totally the various keys on the operating section 25.

The printing engine 26 is image forming means, for example an electronic photography type printer. The printing images are generated from the printing data received from the external personal computers 1, 1 . . . by the CPU 20 performing various processes. The printing images are then printed by the printing engine 26 as hard copies on sheets of recording paper or OHP (over head projector) films at an optimum size selected from A3 vertical, B4 vertical, A4 vertical, B5 horizontal, or A5 horizontal and the like.

It would be understood that the printing engine 26 is not limited to the electronic photography type printer but may be of ink jet type, thermal printing type, or sublimation type adopted for image forming.

The NIC 27 is an interface for connection with the network N for exchanging various data between the printer 2 and the personal computer 1 connected to the network N. The NIC 27 serves as a data acquiring means for acquiring the printing data including text data from the personal computer 1.

The personal computer 1 includes, as shown in FIG. 1, a CPU 10, a ROM 11 for storing a computer program indicative of a control procedure of the CPU 10, a RAM 12 for temporarily storing various data generated by the controlling action of the CPU 10, an HDD 13, an NIC 14, and others which are connected to each other via a bus la. The bus la is also connected with a display monitor 15 such as LCD or CRT display, a mouse 16, a keyboard 17, and any other peripheral devices for the personal computer 1.

The CPU 10 is provided for, while controlling of the foregoing hardware components connected via the bus la, reading the control program preliminarily stored in the ROM 11 and the HDD 13 and executing the same in the RAM 12.

The HDD 13 is provided for storing the computer programs necessary for the action of the personal computer 1, application programs for producing electronic documents including texts, pictures, and photographs, and a printer driver for generating the printing data to be received by the printer 2. More particularly, the CPU 10 executes the printer driver in order to convert the electronic documents generated by the user operating the application program into printing data of a PCL or PS format before transmitting the same to the printer 2.

According to the printing system having the above described arrangement, the user of the personal computer 1 drives the CPU 10 in the personal computer 1 to perform the application program to generate an electronic document to be printed. For printing the electronic document generated by the user with the printer 2, the CPU 10 executes the printer driver and produces printing data from the electronic document generated by the user and transmits the produced printing data to the printer 2.

The printer 2 temporarily stores in the HDD 23 the printing data received over the network N from the personal computer 1 before subjecting them to various processing of the CPU 20, and drives the printing engine 26 to print the printing data.

In the printer 2, the decision tables including a printer data table, a printing condition table, a user identification table, and a holding condition table are managed by the decision table managing section 29 in the CPU 20. Those tables are set by the managing person of the printer 2 from the operating section 25 to control the action of the holding action control section 30 in the CPU 20, and then stored in the HDD 23. Generally, the tables may also be set using WEB pages related to the printer 2.

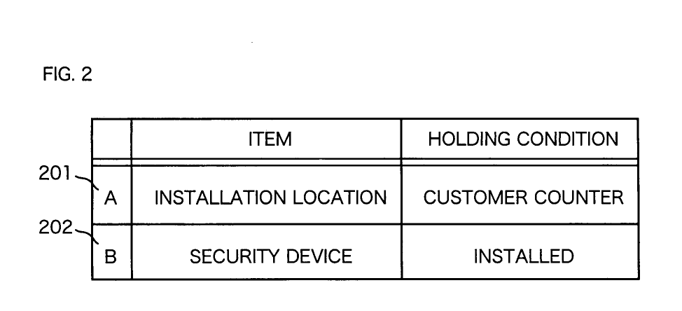

The printer data table may be designed as shown in FIG. 2 where the location information of the printer 2 and the installation information of a security system (installed or not) for erasing the printing data after the completion of the printing action are listed as the holding condition data for determining whether or not the holding action is carried out to protect the confidentiality of the printing data.

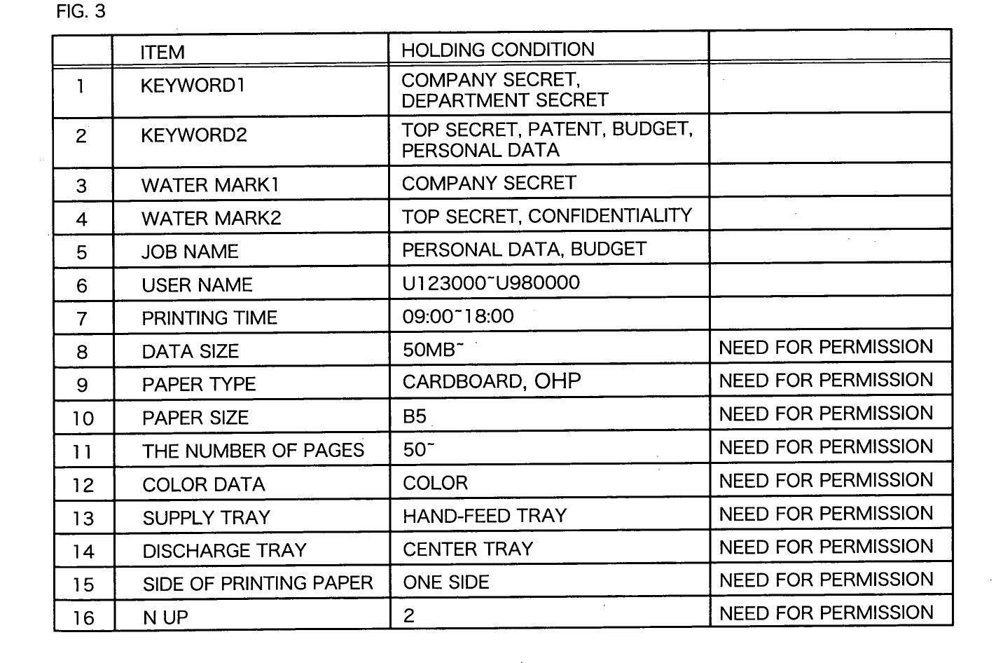

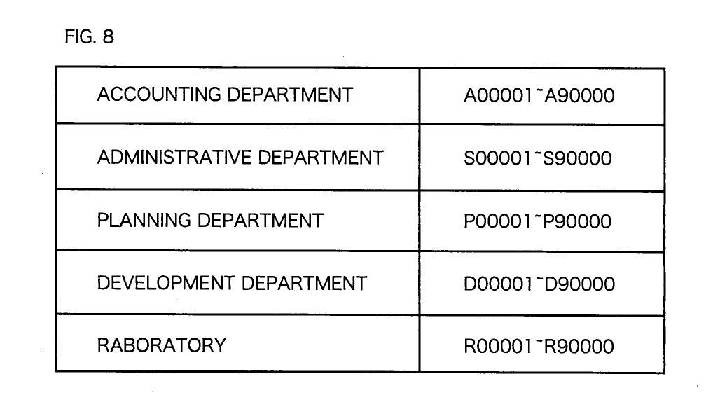

The printing condition table may be designed as shown in FIG. 3 where the printing data information and the printing settings information are listed as the holding condition data for determining whether or not the holding action is carried out to protect the confidentiality of the printing data. The user identification table is designed as shown in FIG. 8 where the name of the department to which the user belongs and the ID data of the user are listed.

For the information about the printer 2, the printer data table shown in FIG. 2 manages information regarding the location, such as a room or a department, of the printer 2 and the installation of a security device (installed or not) in the printer 2 for erasing the printing data after the completion of the printing action.

For the information about the printing data, the printing condition table shown in FIG. 3 manages keyword 1, keyword 2, a water mark, a job name, a user name (or a user ID), a printing time, a data size, a type of printing paper, a size of printing paper, the number of pages, color data, a supply tray, a discharge tray, a side of printing paper, and the N up data (printing of N number of pages in one sheet of paper).

The keyword 1 represents a confidentiality level, such as company secret or department secret, which indicates a range of handling the printing data. The keyword 2 represents a confidentiality level other than that of the keyword 1, indicating another range of handling the printing data. This permits the printing action to be conducted at the confidentiality level of the keyword other than the keyword 1. The job name is for identifying the printing data while the user name (or the user ID) is for identifying to the user who attempts to conduct the printing action.

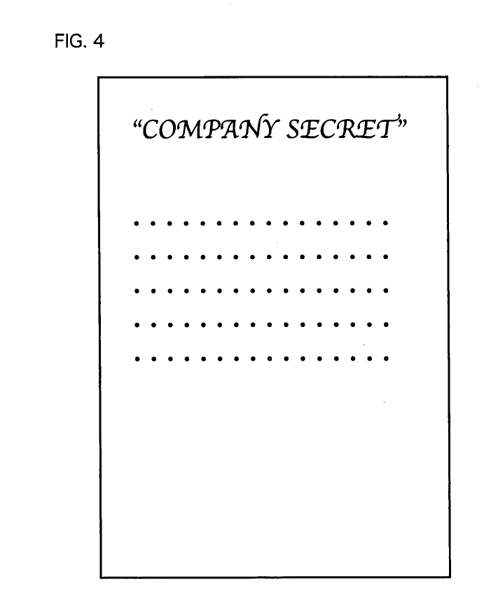

When the printing data contains confidential data, its print often can exhibit a keyword “department secret” or “company secret”, indicating a confidential document. FIG. 4 is an explanatory view showing an example of a print of such printing data.

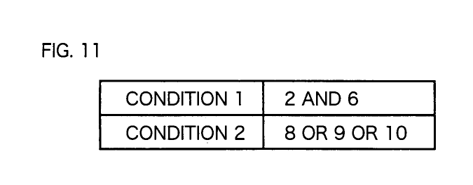

The holding condition table is designed as shown in FIG.11. With the table, it is possible to set the holding conditions in a restricted manner, by combining data items (indicated by signs and item numbers in FIGS. 2 and 3 and item numbers) which is related to the printing data, including the aforementioned holding conditions which serves as conditions for conducting a holding action. When the holding conditions for the printing data (the item numbers) are related with “or”, the holding action is conducted on the printing data assigned with any of the holding conditions.

When the information (the symbol and item numbers) about the printing data are related with “and”, the holding action is conducted on the printing data when the assigned with all the holding conditions. In case of the condition denoted by 1 for example, the holding action is conducted when the printing data is accompanied with any of the keywords 2 (at the numeral 2), such as “top secret”, “patent”, “budget”, and “personal data”, and a user name (at the numeral 6) ranging from U123000 to U980000 in added to the printing data.

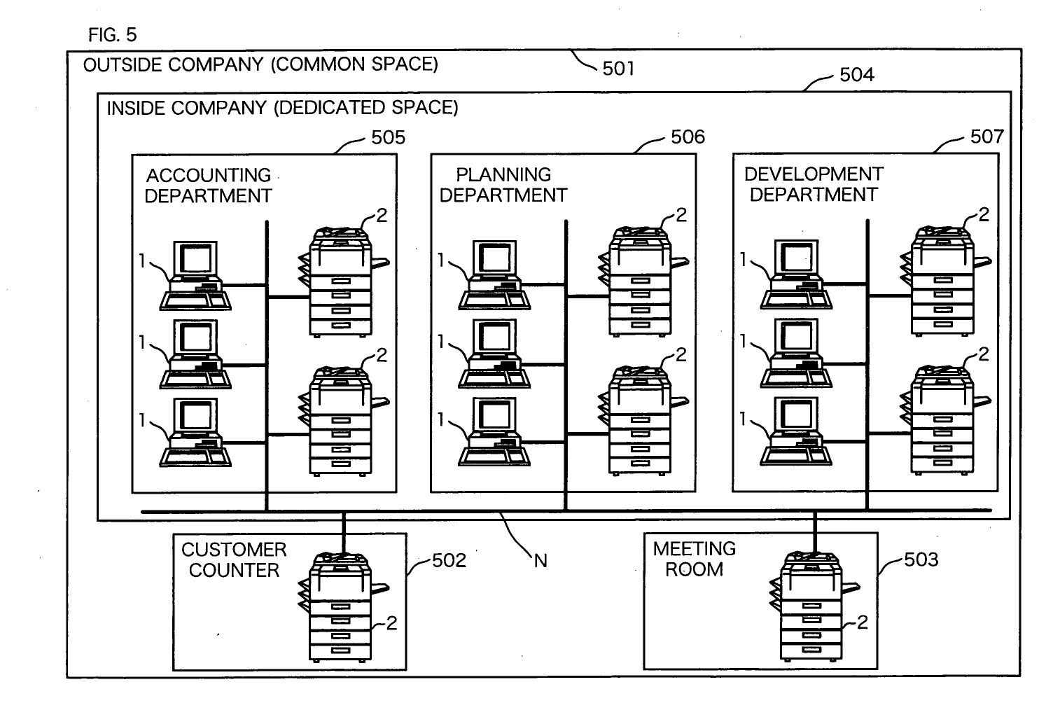

FIG. 5 is an explanatory view schematically showing an installation location of the personal computers 1 (a user who conducts printing) and the printers 2 (FIG. 1). Groups of the personal computers 1 (FIG. 1) connected to two or more of the printers 2 (FIG. 1) over one network N, such as a LAN, constituting a printing system are located in a dedicated space 504 in a company which is separated into an accounting department 505, a planning department 506, and a development department 507. There is provided a common space 501 outside the company where a customer counter 502 and a meeting room 503 are located, each equipped with the printer 2 (FIG. 1) connected to the network N.

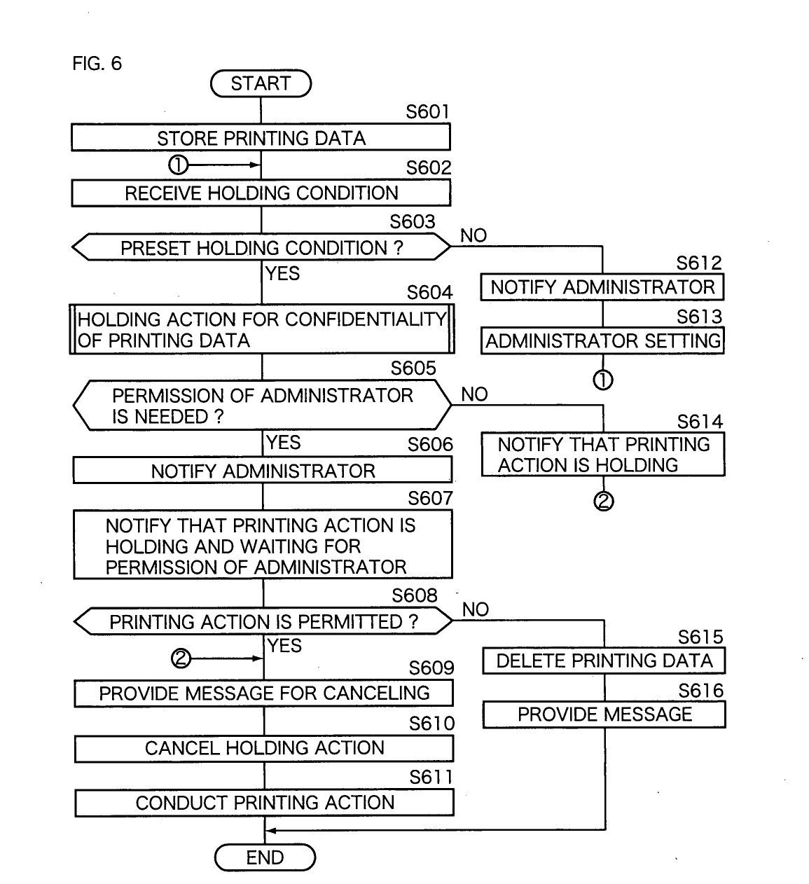

The action of the printer 2 having the foregoing arrangement will be described referring to the flowcharts of FIGS. 6, 7, 9, and 10. The action starts with the CPU 20 in the printer 2 receiving the printing data (assigned with a keyword e.g., “company secret”) via the NIC 27 from the personal computer 1 over the network N and instructing the controller 28 to store the printing data in the HDD 23 (S601). Then, the decision table managing section 29 is operated to receive the holding condition from the holding condition table (FIG. 11) (S602) and determines whether the holding condition including the installation location 201 of the printer data table (FIG. 2), the security device 202, and the keyword 1 (301) to N up data 316 in the printing condition table (FIG. 3) is preset or not (S603).

When determining (at S603) that the holding conditions are preset, the CPU 20 instructs the holding action control section 30 to conduct the holding action for protecting the confidentiality of the printing data through referring the printer data table (FIG. 2), the printing condition table (FIG. 3), the user identification table (FIG. 8), and other decision tables (S604). The holding action for each condition will be described later.

When determining (at S603) that the holding conditions are not preset, the CPU 20 instructs the decision table managing section 29 to provide the personal computer 1, which controls the printer 2, with a message “Set holding conditions” and notify the administrator of the setting (S612). This is followed by the administrator setting the holding conditions (S613) and the decision table managing section 29 repeating the acquisition of the holding conditions from the holding condition table (FIG. 11) (S602).

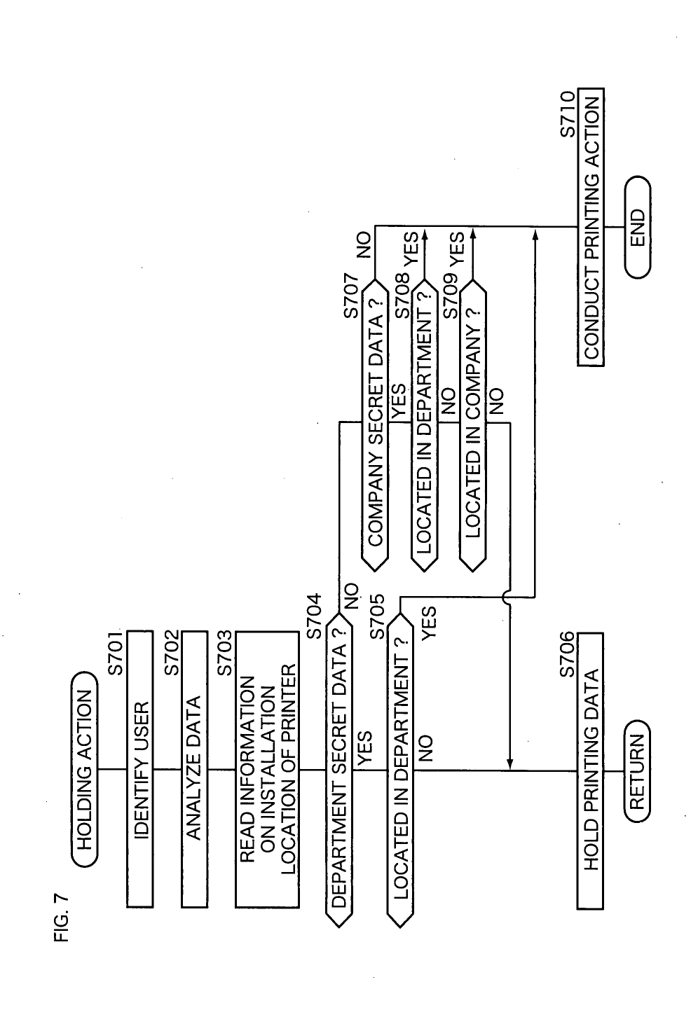

FIG. 7 illustrates a flowchart of conducting the holding action (S604) for protecting the confidentiality of the printing data according to the keyword 1 (at 301) assigned to the printing data and the location of the printer 2. When determining (in S603) that the holding conditions are preset, the CPU 20 instructs the holding action control section 30 to identify the department of the user from the user name and the user ID table (FIG. 8) assigned to the printing data stored in the HDD 23 (S701). The user name (or the user ID) is a piece of information assigned to the printing data by the personal computer 1 and can thus be used for identifying the user who attempts to conduct the printing action. It is hence determined which one of the departments 501 to 507 the user belongs to.

Then, the CPU 20 instructs the holding action control section 30 to analyze the printing data for retrieving the keyword 1 (a keyword indicative of a range of handling the confidential data) (S702). The holding action control section 30 also obtains information on the installation location of the printer 2 from the printer data table (FIG. 2) (S703).

The CPU 20 instructs the holding action control section 30 to determine from the result of the step of identifying the department of the user (S701), the step of retrieving the keyword 1 (S702), and the step of obtaining information on the installation location of the printer 2 (S703) whether or not the printing data stored in the HDD 23 is department secret data (S704).

When determining, for example, that the user belongs to the accounting department 505 (FIG. 5), the printing data is department secret data (S704), and the printer 2 on the output side is not located in the accounting department 505 (S705), the CPU 20 instructs the holding action control section 30 to hold the printing data (or suspend the start of the printing action) (S706) and return its action to the start. When determining (in S705) that the printer 2 on the output side is located in the accounting department 505, the CPU 20 does not hold the printing data and instructs the printing engine 26 to conduct the printing action (S710).

When determining that the user belongs to the accounting department 505 (FIG. 5), the printing data is not protected with the department secret data but the company secret data (S707), and the printer 2 on the output side is not located either in the accounting department 505 (S708) or the dedicated space 504 (S709), the CPU 20 instructs the holding action control section 30 to hold the printing data (S706) and returns its action to the start.

When determining that the printing data is company secret data (S707) and the printer 2 on the output side is located in the accounting department 505 (S708) or the dedicated space 504 (S709), the CPU 20 does not hold the printing data and gives an instruction to conduct the printing action (S710).

When determining that the printing data is not department secret data (S704) or the company secret data (S707), the CPU 20 does not hold the printing data and gives an instruction to conduct a printing action (S710). As described above, the holding action can selectively be carried out depending on the installation location of the printer 2 and the presence of the keyword which is indicative of the confidentiality of the printing data, thus protecting the confidentiality of the printing data.

As for protecting the confidentiality of the printing data, alternatively to the action shown in FIG. 7., in the case when the leakage of confidential data from a stolen HDD 23 is a matter of apprehension of a company, the printing data may be outputted immediately without being subjected to a holding action when company secret data is outputted to the printer 2 located outside the company. This is intended to avoid the leakage of the confidential data by avoiding a holding action of the printing data at the HDD 23.

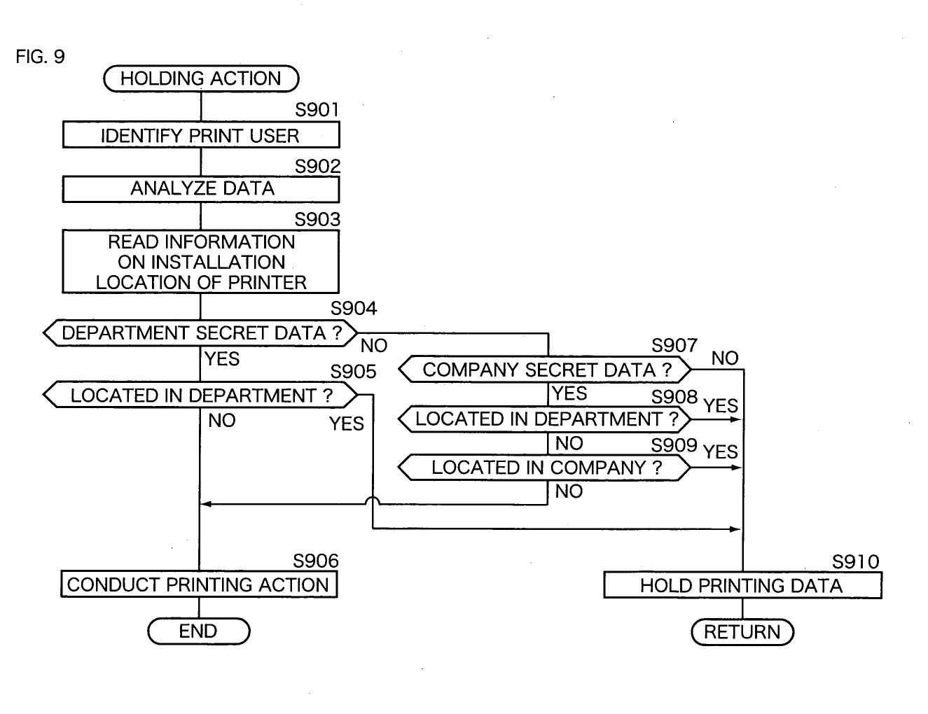

FIG. 9 illustrates a flowchart of protecting the confidentiality of the printing data (S604) by avoiding a holding action of the printing data a storage device such as the HDD 23. The action starts with the CPU 20 instructing the holding action control section 30 to identify the department of a user, who attempts to access the printing data stored in the HDD 23, from the user named and the user identification table (FIG. 8) if (in S603) the holding condition table (FIG. 11) includes the holding conditions specified by the keyword 1 (301) (1) and the installation location (A) of the printer 2 (S901). The user name (or the user ID) is a piece of information assigned to the printing data by the personal computer 1 for specifying the printing action, which identifies the user who attempts to start the printing action. It is hence determined which one of the areas 501 to 507 the user belongs to.

Then, the CPU 20 instructs the holding action control section 30 to analyze the printing data and retrieve the keyword 1 (which specifies a range of handling the confidential data) (S902). This is followed by the holding action control section 30 obtaining the installation location data of the printer from the printer data table (FIG. 2) (S903).

The CPU 20 further instructs the holding action control section 30 to determine (S904) whether or not the printing data stored in the HDD 23 is protected with the department secret data from the result of the steps of identifying the department of the user (S901), retrieving the keyword 1 (S902), and obtaining the installation location data of the printer (S903).

When determining, for example, that the user belongs to the accounting department 505 (FIG. 5), the printing data is protected with the department secret data (S904), and the printer 2 on the output side is not located in the accounting department 505 (S905), the CPU 20 instructs the printing engine 26 to conduct a printing action (S906). When determining (in S905) that the printer 2 on the output side is located in the accounting department 505, the CPU 20 instructs the holding action control section 30 to hold the printing data (or suspend the start of the printing action) and returns its action to the start (S910).

When determining that the user belongs to the accounting department 505 (FIG. 5), the printing data is not department secret data (S904) but company secret data (S907), and the printer 2 on the output side is not located in either the accounting department 505 (S908) or the dedicated space 504 (S909), the CPU 20 gives an instruction to conduct a printing action (S906).

When determining that the printing data is company secret data (S907) and the printer 2 on the output side is located in the accounting department 505 (S908) or the dedicated space 504 (S909), the CPU 20 holds to hold the printing data (S910) and returns its action to the start. When determining that the printing data is not department secret data (S904) or company secret data (S907), the CPU 20 holds the printing data (S910) and returns its action to the start.

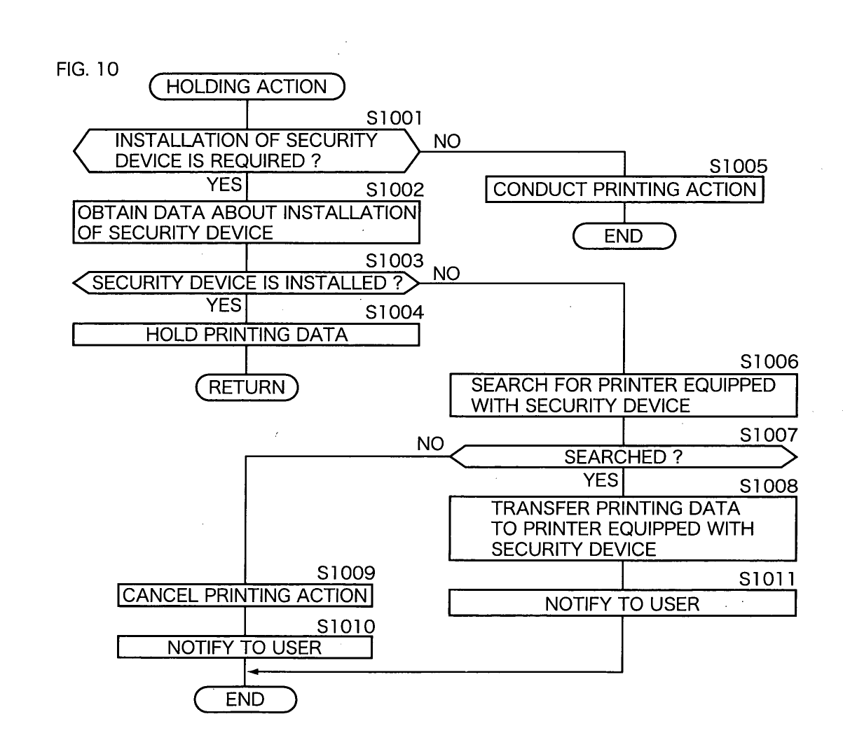

FIG. 10 is a flowchart showing an example of the holding action (S604) to protect the confidentiality of the printing data on the basis of the security device for erasing the printing data subjected to the holding action after the printing action. The action starts with the CPU 20 instructing the decision table managing section 29 to obtain the holding conditions from the holding condition table (FIG. 11) (S602) and determining whether or not the holding conditions specified by the keyword 1 (301) (1) in the printing condition table (FIG. 3) as well as the security device 202 (B) in the printer data table (FIG. 2) are preset (S603). When determining that the holding conditions are preset, the holding action control section 30 analyzes the printing data and retrieves the keyword 1 (which specifies a range of handling the confidential data) to determine whether or not the printing data are accompanied with the holding conditions in relation to the installation of the security device (S1001). It is determined that the holding conditions are added when the printing data include the keyword 1.

When determining (in S1001) that the holding conditions for the installation of the security device are not added, the CPU 20 instructs the printing engine 26 to conduct the printing action (S1005). When determining (in S1001) that the holding conditions for the installation of the security device are added, the CPU 20 instructs the holding action control section 30 to obtain the data 202 about the installation of the security device from the printer data table (FIG. 2) (S1002) and determines whether the security device is installed or not (S1003). When determining that the security device is installed, the CPU 20 conducts the holding of the printing data (or suspending the start of the printing action) (S1004) and returns its action to the start.

When determining (in S1003) that the security device is not installed, the CPU 20 instructs the holding action control section 30 to refer to the printer 2 for the printer data table (FIG. 2) and search for the printer 2 equipped with the security device (S1006). When determining (in S1007) that the printer 2 equipped with the security device is present, the CPU 20 determines that the printing data is to be transferred in S1007 and transferring the printing data to the printer 2 equipped with the security device (S1008). After the transfer of the printing data and the destination is notified to the user (S1011), the action is terminated. When the printing data is received, the action follows as shown in the flowchart of FIG. 7.

When determining (in S1007) that the printer 2 equipped with the security device is not present, the CPU 20 cancels the printing action (S1009). After the cancellation of the printing action is notified to the user (S1010), the action is terminated. Accordingly, the holding action can selectively be conducted through examining the installation of the security device to the printer, hence protecting the confidentiality of the printing data at higher certainty.

The action of the flowchart shown in FIG. 6 will now be described after the step of the holding action (S604) where the holding of the printing data (or suspending of the start of the printing action) has been performed and the action is returned to the routine. After the holding of the printing data (or suspending of the start of the printing action) is performed (in S604) and the action is returned to the routine, the CPU 20 instructs the decision table managing section 29 to determine whether or not the printing condition table (FIG. 3) specifies that permission of the administrator of the printer 2 is needed for conducting the printing action (S605). When determining that the requirement is needed, the CPU 20 provides the personal computer 1 of the administrator of the printer 2 with a message indicative of the printing data subjected to the holding action (S606). The user of the personal computer 1 is then notified that the printing data has been subjected to the holding action and remains in a standby state for waiting for the permission of the printing action from the administrator (S607).

When receiving from the personal computer 1 a message that the action of printing the printing data in the standby state is permitted (S608) in response to the message indicative of the printing data subjected to the holding action (S606), the CPU 20 instructs the holding action control section 30 to provide the personal computer 1 with data (for example, a password, an IC card, or a biometric authentication) required for canceling the holding action (S609). When receiving from the operating section 25 a command for canceling the holding action (S610), the CPU 20 conducts the printing action (S611) and closes its routine.

On the other hand, when determining (in S605) that the printing condition table (FIG. 3) does not include requirement for permission for the printing action, the CPU 20 instructs the holding action control section 30 to provide the personal computer 1 of the user with a message that the printing data is subjected to a holding action (S614) and then notify the computer 1 of data required for canceling the holding action (S609).

When determining (in Step 608) that the message of permitting the printing action is not received, the CPU 20 deletes the printing data (S615) and provides the personal computer 1 of the user with a message indicating that the printing data has been deletes (S616) and closes its routine.

Alternatively, the printer according to the present embodiment can conduct the holding action even when the printing data includes (FIG. 3) a watermark 1 (303) indicative of a level of confidentiality as a condition for conducting a holding action. This allows the holding action shown in the flowchart of FIG. 7 to be selectively conducted even when a keyword 1 (301) is not assigned to the body of the printing data, thus protecting the confidentiality of the printing data.

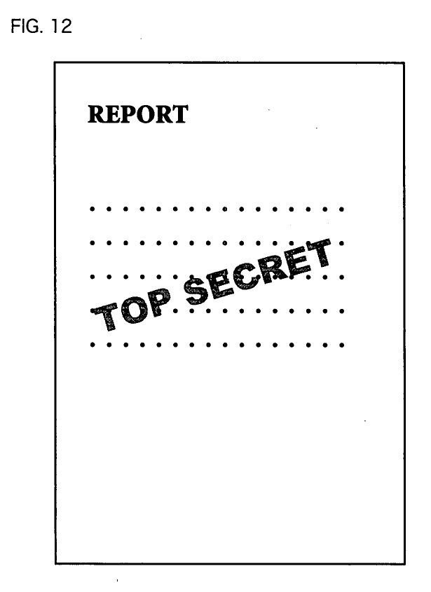

Moreover, the holding action can be conducted (FIG. 3) even when a watermark 2 (304) indicative of the a level of confidentially is assigned to the as a condition for conducting a holding action (FIG. 3) as shown in FIG. 12. This allows the holding action shown in the flowchart of FIG. 7 to be selectively conducted when the keyword 2 (302) is not assigned to the body of the printing data, thus protecting the confidentiality of the printing data.

Furthermore, when a print job name 305 in the printing data indicates a level of the confidentiality as a condition for conducting a holding operation (FIG. 3), the holding action can be selectively conducted more simply and readily, thereby protecting the confidentiality of the printing data.

Furthermore, when a holding action is selected in accordance with a the user name or user ID 306 assigned to the printing data as a condition for conducting a holding operation, intentional or accidental leakage of the printing data (from a company or office) will preliminarily be avoided.

Furthermore, when a holding action is selected in accordance with a printing time 307 for starting the printing action as a condition for conducting a holding action, intentional or accidental leakage of the printing data (from a company or office) will preliminarily be avoided. For example, a condition may be preset that a printer located in a place accessible by many people other than the employees remains disabled with the holding action during a period of time (9:00 to 17:00) during which there are many coming and goings of the people other than the employees, thereby protecting the confidentiality of the printing data.

Furthermore, when a holding action is selected in accordance with a size of the printing data 308 stored in the HDD 23 as a condition for conducting a holding action, when the printing data is large enough in the size to consume a considerable length of time to print, the printing action by a third user may be conducted by priority. Also, when the same data is to be printed again by the same user, the lead time for the printing action will be shortened.

Furthermore, when a action is selected in accordance with a type of printing paper 309 assigned to the printing data as a condition for conducting a holding action, the consumption of a particular type of printing paper 309, for example, which is expensive, by the employees will be suppressed.

Furthermore, when a holding action is selected in accordance with a size of printing paper 310 assigned to the printing data as a condition for conducting a holding action, whereby the consumption of a particular size of printing paper, for example, which is nearly exhausted will be inhibited.

Furthermore, when a holding action is selected in accordance with the number of pages 311 assigned to the printing data as a condition for conducting a holding action, printing in a large amount by the employees will be suppressed.

Furthermore, when a holding action is selected in accordance with a color requirement 312 assigned to the printing data as a condition for conducting a holding action, unnecessary color printing action, for example, for a temporary use within the company will be suppressed.

Furthermore, when a holding action is selected in accordance with paper feed tray information 313 assigned to the printing data as a condition for conducting a holding action, printing on a particular type of paper, from a hand-feed tray, for example, will be suppressed.

Furthermore, when a holding action is selected in accordance with discharge tray information 314 assigned to the printing data as a condition for conducting a holding action, the discharge of printing paper, for example, to any common tray other than an individually dedicated discharge tray will be restricted.

Furthermore, when a holding action is selected in accordance with the number of printing surfaces (one side or both sides) 315 assigned to the printing data as a condition for conducting a holding action, the number of printing paper, for example, which is not printed on both sides will be curbed.

Furthermore, when a holding action is selected in accordance with the N up data (N number of pages printed on one sheet) 316 assigned to the printing data as a condition for conducting a holding action, the printing data, which is not to be printed in a 2-up mode for example, will be reduced.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A printer comprising:
an obtaining section for obtaining a printing data;
a storing section for storing an obtained printing data by the obtaining section;
a printing section for printing based on the printing data stored in the storing section;
a receiving section for receiving information about the printer; and
a controller capable of performing operations of
extracting predetermined information about the printing data from the printing data stored in the storing section; and
executing a process for ensuring the confidentiality of the printing data based on the predetermined information thus extracted and the information received by the receiving section.

2. The printer according to claim 1, wherein the information received by the receiving section includes information which indicates an installation location of the printer.

3. The printer according to claim 1, wherein the information received by the receiving section includes information which indicates whether the printer comprises a processing section for deleting the printing data stored in the storing section after the printing process.

4. The printer according to claim 1, wherein the predetermined information about the printing data includes a keyword which indicates a confidentiality level of the printing data.

5. The printer according to claim 2, wherein the predetermined information about the printing data includes information about an area of an installation location; and
said controller is further capable of operations of:
determining whether or not the installation location of the printer is included in the area; and
executing a process for ensuring the confidentiality of the printing data in accordance with the determination result.

6. The printer according to claim 1, wherein the predetermined information about the printing data includes a mark which indicates a confidentiality level of the printing data.

7. The printer according to claim 1, wherein the predetermined information about the printing data includes a print job name which indicates a confidentiality level of the printing data.

8. The printer according to claim 1, wherein the predetermined information about the printing data includes information for specifying an individual.

9. The printer according to claim 1, wherein the predetermined information about the printing data includes information which indicates a time and/or date when a printing action of the printing data is executed.

10. The printer according to claim 1, wherein the predetermined information about the printing data includes information about a size of the printing data.

11. The printer according to claim 1, wherein the predetermined information about the printing data includes information about a type of paper on which the printing data is printed.

12. The printer according to claim 1, wherein the predetermined information about the printing data includes information about a size of paper on which the printing data is printed.

13. The printer according to claim 1, wherein the predetermined information about the printing data includes information about the number of pages of the printing data to be printed.

14. The printer according to claim 1, wherein the predetermined information about the printing data includes information which indicates that the printing of the printing data is to be performed on both sides or one side of a sheet of paper.

15. The printer according to claim 1, wherein the predetermined information about the printing data includes information about a color of the printing data to be printed.

16. The printer according to claim 1, further comprises a plurality of paper feed trays which contain sheets of paper to be supplied to the printing means;
wherein the predetermined information about the printing data includes information which indicates a paper feed tray for supplying a sheet of paper on which the printing data is to be printed.

17. The printer according to claim 1, further comprises a plurality of discharge trays for ejecting a printed paper;
wherein the predetermined information about the printing data includes information which indicates a discharge tray for ejecting a sheet of paper on which the printing data is printed.

18. The printer according to claim 1, said controller is further capable of performing operations of:
determining whether or not start of printing of the printing data is to be suspended; and
suspending or executing start of printing of the printing data in accordance with the determination result.

19. The printer according to claim 18, further comprises a transfer section for transferring printing data to another printer; wherein
said controller is further capable of performing operations of:
determining whether or not the printing data subjected to the suspension of start of printing is to be transferred by the transfer section to another printer; and
suspending or executing a transfer of the printing data at the transfer section in accordance with the determination result.

20. The printer according to claim 1, said controller is further capable of performing operations of:
determining whether or not the printing data stored in the storing section is to be deleted after completion of the printing process; and
deleting the printing data when it is determined that the printing data should be deleted.

21. The printer according to claim 1, further comprises an inquiring section for making inquiry to outside about the permission/prohibition of printing of the printing data stored in the storing section; and
a receiving section for receiving information related to the permission/prohibition inquired by the inquiring section; wherein
said controller capable of executing printing of the printing data at the printing section, when the receiving section receives information which indicates that the printing is permitted.

22. The printer according to claim 1, further comprises a notifying section for notifying a method for executing printing to outside, when the receiving section receives the information which indicates that the printing is permitted.

23. A printer comprising;
obtaining means for obtaining printing data;
storing means for storing obtained printing data by the obtaining means;
printing means for printing based on the printing data stored in the storing means;
receiving means for receiving information about the printer;
extracting means for extracting predetermined information about the printing data from the printing data stored in the storing means; and
means for executing a process for ensuring the confidentiality of the printing data based on the extracted information and the received information by the receiving means.

24. The printer according to claim 23, further comprises means for determining whether or not start of printing of the printing data is to be suspended; and
means for suspending or executing start of printing of printing data with the printing means in accordance with the determination result.

25. The printer according to claim 24, further comprises transfer means for transferring printing data to another printer;
means for determining whether or not the printing data subjected to the suspension of start of printing is to be transferred by the transfer means to another printer; and
means for suspending or executing a transfer process of the printing data with the transfer means in accordance with the determination result.

26. The printer according to claim 23, further comprises means for determining whether or not the printing data stored in the storing means is to be deleted after completion of the printing process; and
means for deleting the printing data when it is determined that the printing data should be deleted.

27. The printer according to claim 23, further comprises inquiring means for making inquiry to outside about the permission/prohibition of printing of the printing data stored in the storing means; and
receiving means for receiving information related to the permission/prohibition of printing inquired by the inquiring means; wherein
a printing process of the printing data is executed by the printing means, when the receiving means receives information which indicates that the printing is permitted.

28. The printer according to claim 27, further comprises means for notifying a method for executing the printing process to outside, when information which indicates that the printing is permitted is received.
